(19) United States
(12) Patent Application Publication
(10) Pub. No.: US 2017/0175050 A1
(43) Pub. Date: Jun. 22, 2017

(54) Fine-Particulate Bleaching Catalysts, Process for Their Preparation and Their Use

(71) Applicant: WeylChem Wiesbaden GmbH, Wiesbaden (DE)

(72) Inventors: Paula BARRELEIRO, Ginsheim (DE); Gerhard SCHWARZ, Hanau (DE); Andreas SCHOTTSTEDT, Hofheim (DE); Roman MORSCHHÄUSER, Mainz (DE)

(21) Appl. No.: 15/379,573

(22) Filed: Dec. 15, 2016

(30) Foreign Application Priority Data
Dec. 18, 2015 (DE) 10 2015 016 402.3

(51) Int. Cl. C11D 3/395; C11D 17/06

(52) U.S. Cl. CPC C11D 3/3951; C11D 17/065

(57) ABSTRACT

Disclosed are fine-particulate powders containing particles with at least 80% by weight of a manganese complex with nitrogen-containing ligands, wherein one or more of the ligands are macrocyclic ligands, wherein at least 70% by weight of the particles have particle sizes in the range from 1 μm to 50 μm, at most 15% by weight of the particles have particle sizes >50 μm and at most 15% by weight of the particles have particle sizes <1 μm, wherein the percentages refer to the total amount of the particles.

These powders can be used as bleaching catalysts in washing and cleaning agents and display an improved activity and at the same time these are toxicologically non-hazardous during manufacturing and use.

### CLAIM FOR PRIORITY

This application is based on German Patent Application No. 10 2015 016 402.3, filed Dec. 18, 2015, the priority of which is hereby claimed and the disclosure of which is incorporated herein by reference.

### TECHNICAL FIELD

The present invention relates to particle-shaped bleaching catalysts with defined particle size distribution, a process for their production and their use in detergents and cleaning agents, especially in products for the machine cleaning of dishes.

### BACKGROUND

To get spotless dishes persalts, such as perborates and percarbonates, are used as bleaching agents in dishwashing agents. To activate these bleaching agents and to achieve a satisfactory bleaching effect when cleaning at temperatures of 60° C. and below, the dishwashing agents in general furthermore contain bleaching activators or bleaching catalysts, where in particular the bleaching catalysts have proved particularly effective.

Bleaching catalysts are highly reactive and are used preferably in small quantities in machine dishwashing agents for the machine cleaning, for example, in amounts of 0.002 to 2% by weight, based on the complete dishwashing agent.

Due to the very low usage amount of bleaching catalysts, a homogeneous distribution of bleaching catalyst in the dishwashing agent formulation is hard to accomplish.

State of the art is to use bleaching catalysts in the form of ready-made granulates to improve the storage stability and to achieve a most homogeneous dosage.

WO 2011/066935 A2 corresponding to EP 2 507 251 A2 discloses bleach catalyst compounds containing selected manganese complex compounds as bleaching catalysts and selected organic carrier materials, especially salts of short-chain alkylbenzene sulfonic acids with less than 3 carbon atoms in the alkyl chain. The compounds may optionally be coated. In this document apart from the mentioning of the existence in powder form there is no reference on the particle sizes of the bleaching catalysts. Because no specific disintegration measures are described, these should be in the range of significantly above 50 μm.

WO 2010/115582 A1 corresponding to EP2 417 240 A1 teaches co-granulates containing a granulated core and a protective or coating layer surrounding the granulated core. These co-granulates are characterized by the fact that the granulated core contains bleach activators and binders and that the protective or coating layer contains one or more bleaching activators and one or more coating agents. Also in this document apart from the mentioning of the existence in powder form there is no reference on the particle sizes of the bleaching catalysts. Because no specific disintegration measures are described, these should be in the range of significantly above of 50 μm. For the co-granules particle diameters from 0.2 to 2 mm are specified.

WO 97/22680 A1 describes particle-shaped compositions containing small amounts of bleaching catalyst and enzymes on carrier substrates. Preferably bleaching catalysts containing cobalt or manganese are used. For the bleaching catalysts particle sizes of less than 300 μm, preferably from 10 to 100 μm are specified. This document contains no reference how these fine-shaped bleaching catalysts are manufactured.

DE10 2006 036 896 A1 discloses a detergent and cleaning agent with size-optimized bleaching agents. Described are solid washing or cleaning agents containing a particle-shaped alkali percarbonate with an average particle size in the range of 1 to 2 mm and particles containing a bleach-enhancing transition metal complex compound with a mean particle size in the range of 0.8 to 1.6 mm.

DE 60 2004 005 849 T2 corresponding to EP 1 625 196 B1 discloses stable particle-shaped compositions containing bleaching catalysts. These contain fine-particulate bleaching catalysts with a mean particle size of <35 μm, alkali, earth alkali and/or aluminium salts, a selected water soluble, meltable and/or thermoplastic binder and water. The used bleaching catalysts are very fine-particulate and typically have mean particle sizes in the range from 10 nm to 10 μm, with 90% of the particles having sizes of <7 μm. The manufacture of the fine-particulate bleach catalyst powders is effected by wet milling or by milling of powders in the presence of dry ice. In doing so preferably mills are used, which allow a high energy input. In the execution examples a bleach catalyst is used. This is a manganese complex, which has a multi-dentate, non-macrocyclic ligand. This manganese complex can be ground into a fine powder by using different mills. This document states, that the effect of the bleach catalysts is significantly intensified by a very fine grain size of the active substance, whereby the bleaching effect is additionally intensified by adding alkali, earth alkali or aluminium salts without at the same time affecting the storage stability of the granulates.

Among the so far on the market place available bleach catalysts manganese complexes, including those with ligands comprising nitrogen or electron donor function, have proved particularly effective.

To achieve an optimum effectiveness of bleaching catalysts and their most homogeneous distribution in the detergent and cleaning agents, the particle size of the bleaching catalysts should be minimised as far as possible. Particles with diameters exceeding 50 μm are distracting for processing in spray processes. On the other hand, the proportion of very fine particles, for example of those with particle sizes of less than 1 μm, should be limited to minimize inhalation-toxic hazards. Therefore particle size distributions as narrow as possible should be sought.

In the search after crushing methods of ligand-manganese complexes with nitrogen donor functions, wherein one or more of the ligands are macro-cyclic ligands, it turned out, that these complexes due to their rod-shaped crystal form are often difficult to crush. It is assumed that the crystals of these manganese complexes only align themselves in some mills by virtue of their needlelike shape and are difficult to crush.

Therefore methods have been sought that allow crushing of these bleaching catalysts and that can be provide bleaching catalysts in volume-average particle sizes in the range from 1 μm to 50 μm, wherein only a small percentage of very fine-particulate and of coarse-particulate particles will be generated.

An object of the present invention is therefore, to provide manganese complexes with selected nitrogen-containing ligands that show an increased effectiveness as bleaching catalysts on the one hand and that can be incorporated in detergents and cleaning agents as homogeneously as possible.

### SUMMARY OF INVENTION

The invention relates to fine-particulate powders, containing particles with at least 80% by weight of a selected manganese complex, in particular of a manganese complex of the formula (1) or formula (2) described below.

These powders are characterised by a content of at least 70% by weight of particles with particle sizes in the range from 1 μm to 50 μm, of at most 15% by weight of the particles with particle sizes >50 μm and of at most 15% by weight of the particles with particle sizes <1 μm, wherein the percentages refer to the total amount of the particles.

The particle sizes specified in this description are determined by laser diffraction using the standard ISO13320 (2009).

The specification for particle sizes refers to the sizes of the primary particles. The powders of the invention may also contain aggregates of the primary particles. Typically, the size of these aggregates is from 5 μm to 5000 μm.

Preferred powders of the invention are characterised by a content of at least 90% by weight of particles with particle sizes in the range from 2 μm to 50 μm, of at most 5% by weight of the particles with particle sizes >50 μm and of at most 5% by weight of the particles with particle sizes <2 μm, wherein the percentages refer to the total amount of the particles.

In a particularly preferred embodiment the powders of the invention have volume-average particle sizes D₅₀ in the range of 2 μm to 25 μm.

D₅₀ means that 50 volume % of the particles are smaller than the value specified for D₅₀. Similarly, D₉₇ means that 97 volume % of the particles are smaller than the value specified for D₉₇. Similarly, D₉₉ and D₁₀ mean that 99 or 10 volume % of the particles are smaller than the value specified for D₉₉ or D₁₀.

In a very preferred embodiment of the invention the powders have volume-average particle sizes of D₉₉<50 μm and D₁₀<5 μm.

In another most preferred embodiment of the invention the powders have volume-average particle sizes of D₉₇<50 μm and D₁₀<5 μm.

In another most preferred embodiment of the invention the powders have volume-average particle sizes of D₉₉<50 μm and D₁₀<1 μm.

Most preferred powders of the invention contain no particles with particle sizes of more than 100 μm or no particles with particle sizes of less than 100 nm.

In another particularly preferred embodiment of the invention the powders have volume-average particle sizes D₉₇ in the range of 8 μm to 35 μm.

In another most preferred embodiment of the invention powders have volume-average particle sizes D₉₇ in the range of 10 μm to 30 μm.

In yet another most preferred embodiment of the invention the powders have volume-average particle sizes D₉₇ in the range of 11 μm to 25 μm.

In yet another most preferred embodiment of the invention the powders have volume-average particle sizes D₉₇ in the range of 12 μm to 20 μm.

The particle size distribution of the powders of the invention can be monomodal or polymodal, especially monomodal or bimodal and very particularly preferred monomodal. The distribution can be symmetric or asymmetric.

As bleaching catalysts used in the context of the present invention bleach intensifying manganese complexes with nitrogen containing ligands are used.

In the invention manganese complexes with nitrogen-containing ligands are used, wherein one or more of the ligands are macrocyclic ligands, preferably manganese complexes in the oxidation state II, III or preferably IV, which contain one or more macrocyclic ligand(s) with the donor functions N and/or NR, in which R stands for a hydrocarbon residue with up to 20 C-atoms, preferably with up to 5 C-atoms, and very preferred for methyl, ethyl or propyl.

Preferably manganese complexes are selected with ligands selected from the group consisting of 1,4,7-trimethyl-1,4,7-triazacyclononane, 1,4,7-triazacyclononane, 1,5,9-trimethyl-1.[delta].[theta]-triazacyclododecane, 2-methyl-1,4,7-trimethyl-1,4,7-triazacyclononane, 2-methyl-1,4,7-triazacyclononane, 1,2-bis-(4,7-dimethyl-1,4,7-triazacyclo-nono-1-yl) ethane, cyclam or its methylsubstituted derivatives and/or cyclen or its methylsubstituted derivatives, preferably 1,8-dimethylcyclam, 1,7-dimethylcyclen, 1,8-diethylcyclam, 1,7-diethylcyclen, 1,8-dibenzylcyclam or 1,7-dibenzylcyclen.

Especially preferred ligands are 1,4,7-trimethyl-1,4,7-triazacyclononane (Me-TACN), 1,4,7-Triazacyclononane (TACN) or bridged ligands, such as 1,2-bis-(4,7-dimethyl-1,4,7-triazacyclonono-1-yl) ethane (Me4-DTNE), as described, for example, in EP 0 458 397, EP 0 458 398, EP 0 549 272, EP 0 530 870, WO 96/06154, WO 96/06157 or WO 2006/125517.

Especially preferred bleaching catalysts used in the context of the present invention are bleaching intensifying manganese complexes of the following formula (1) or the following formula (2)

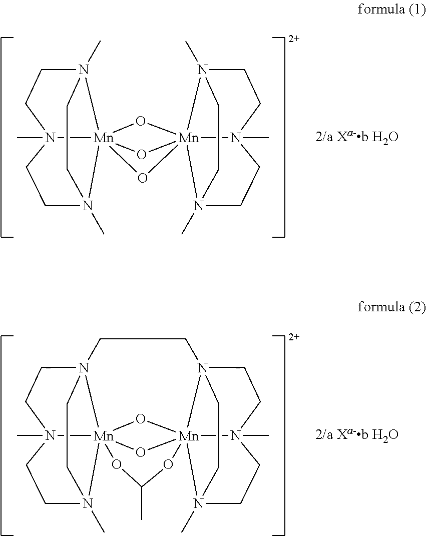

wherein a is 1 or 2, b is a number from 0 to 4, X stands for an arbitrary monovalent or bivalent anion, preferably for an anion of a carboxylic acid, for a halide anion, for a sulfate anion or for a hexafluorophosphate anion, for a hexafluoroantimonate anion or for a tetrafluoroborate anion, in particular for PF₆⁻, CH₃COO⁻, Cl⁻, SO₄²⁻, and particularly for PF₆⁻.

Further details and preferred aspects of the invention are discussed below.

### DETAILED DESCRIPTION

Especially preferred powders contain as a bleaching catalyst bis (N,N′,N″-trimethyl-1,4,7-triazacyclononane)-trioxo-dimanganese (IV) di(hexafluorophosphate) monohydrate, which is available as Peractive® MnTACN.

The manganese complexes with nitrogen containing ligands, whereby of the ligands one ore more are macrocyclic ligands, preferably the manganese complexes of the formulae (1) or (2), are present in the fine-particulate particles in at least 80% by weight, preferably in at least 90% by weight and particularly preferred between 95 and 100% by weight.

It was found that fine-particulate powders containing particles with at least 80% by weight of manganese complexes with nitrogen-containing ligands, wherein of the ligands one or more are macrocyclic ligands, preferably of a manganese complex of formula (1) or formula (2), can be manufactured by a selected milling process, wherein the fine-particulate powders in particular are characterized in that these contain at least 70% by weight of particles with particle sizes in the range from 5 μm to 50 μm, no more than 15% by weight of the particles with particle sizes of >50 μm and no more than 15% by weight of the particles with particle sizes of <; 5 μm, wherein the percentages refer to the total amount of the particles.

This process includes the measures
i) introduction of a milling stock of particulate material comprising at least 80% by weight of manganese complexes with nitrogen-containing ligands, wherein of the ligands one or more are macrocyclic ligands, preferably of a manganese complex of formula (1) or formula (2) into a milling device selected from the group consisting of a jet mill or a pen mill equipped with a cooling device, wherein the milling device is equipped with a separator device,
ii) milling of the particulate material to a fine-particulate powder, with the proviso that
iii) the temperature of the milling stock during the milling process does not exceed 95° C.

The milling step ii) preferably takes place under such conditions, that at least 70% by weight of the total amount of the obtained particles of the fine-particulate powder possess particle sizes in the range of 1 μm to 50 μm, up to 15% by weight of the particles possess particle sizes of >50 μm and up to 15% by weight of the particles possess particle sizes of <1 μm.

Preferred temperatures of the milling stock during the milling process are from −15° C. to 95° C., preferably <70° C., particularly preferred <60° C., and particularly preferred <50° C. to avoid decomposition of the Mn-complex. This can be achieved by supply of cooling gas, such as for example air with a temperature from −45° C. to 25° C. or by supply of liquefied gases, such as nitrogen, oxygen or air, during the milling process.

With the process of the invention a gentle method for crushing of bleach catalyst particles to defined particle sizes is provided, in which no or only a very low loss of bleaching catalyst occurs as a result of decomposition during the milling process.

The proportion of defined particle sizes can be controlled by combining the above mentioned milling devices with a separator device.

Preferably, the coarse particles separated in separator device are reintroduced into the jet mill or into the cooled pen mill.

Especially preferred the manganese complexes containing particulate material is milled in a dry state.

In particular the jet mill is used as a milling device in the process of the invention, which is operated with a gaseous fluid and thus is cooled at the same time. Preferably used fluids are air or nitrogen, which are optionally pre-cooled by using suitable heat transfer agents to enhance the cooling effect of these fluids.

By using these selected milling devices in combination with a separator device, it is possible to generate the desired fine-particulate powders without accepting significantly negative properties affecting the quality of the milled product, such as partial or complete decomposition, discoloration, or product bonding. Significantly, in this context, means a maximum decomposition of 10% of the originally contained manganese complex. Preferred, however, are values of at most 5% or most preferred no degradation of the proportion of the originally contained manganese complex.

With other milling devices, for example by using grinding mills, rolling chairs, pin mills without additional cooling, as well as hammer mills and impact mills, creation of fine-particulate powders with unchanged activity in terms of the active content and color retention of the manganese complex does not succeed.

In a particularly preferred embodiment of the process of the invention particles with a very broad particle size distribution of 2 μm to 0.1 mm containing 80 to 100% by weight of a manganese complex with nitrogen containing ligands, wherein of the ligands one or more are macrocyclic ligands, in particular of a manganese complex of formula (1) or of formula (2), are milled in a dry process using an air-powered jet mill containing downstream a separator device.

The powders of the invention are suited as bleaching catalysts for per-compounds in washing and cleaning agents. This use is also subject of the present invention.

The washing and cleaning agents preferably are dishwashing agents, in particular machine dishwashing agents.

Also subject of the present invention are washing and cleaning agents, in particular dishwashing agents, containing the powder of the invention with the above-defined volume-average particle sizes and containing a manganese complex with nitrogen-containing ligands, wherein of the ligands one or more are macrocyclic ligands, preferably a manganese complex according to formula (1) or to formula (2).

The washing and cleaning agents of the invention preferably contain a per-compound.

The washing and cleaning agents of the invention products contain the above-disclosed fine-particulate powders, preferably applied on a carrier material and/or as a compound with a bleach activator.

The powders of the invention with the above defined particle sizes and containing as bleaching catalyst a manganese complex with nitrogen-containing ligands, wherein one or more of the ligands are macrocyclic ligands, preferably a manganese complex according to formula (1) or formula (2), can be mixed with other agents and can be granulated.

Mixtures or ganulates of the powders of the invention with other agents typically contain at least 2% by weight of manganese complex.

Appropriate agents are bleaching activators, surfactants, enzymes, binders, builders, dispersants, inert materials and/or further additives.

As bleaching activators are considered multiple acylated alkylenediamines, in particular tetraacetylethylenediamine (TAED), acylated triazine derivatives, preferably 1,5-diacetyl-2,4-dioxohexahydro-1,3,5-triazine (DADHT), acylated glykoluriles, preferably tetraacetylglykoluril (TAGU), N-acylimides, preferably N-nonanoyl-succinimide (NOSI), acylated phenolsulfonates, preferably n-nonanoyloxi- or n-lauroyloxibenzene sulfonate (NOBS or LOBS), acylated phenolcarboxylic acids, preferably nonanoyloxi- or decanoyloxibenzoic acid (NOBA or DOBA), carboxylic acid anhydrides, preferably phthalic acid anhydride, acylated polyvalent alcohols, preferably triacetin, ethylenglycol diacetate and 2,5-diacetoxy-2,5-dihydrofuran as well as acetylated sorbitol and mannitol or their mixtures, respectively (SORMAN), acylated sugar derivatives, preferably pentaacetylglucose (PAG), pentaacetylfructose, tetraacetylxylose and octaacetyllactose as well as acetylated and optionally N-alkylated glucamine and gluconolactone, and/or N-acylated lactames, for example N-benzoyl-caprolactame. Hydrophilic substituted acylacetals and acyllactames are also preferably used.

In addition, nitrile derivatives such as n-methyl morpholinium acetonitrile methyl sulfate (MMA) or cyanomorpholine (MOR) may be used as bleach activators. Also combinations of conventional bleaching activators may be used.

TAED, NOBS and DOBA are particularly preferred bleaching activators.

The weight ratio of bleaching catalyst(s) to bleaching activator(s) is typically from 1 to 2000 to 1 to 5, preferably 1 to 1000 to 1 to 500, and most preferred from 1 to 100 to 1 to 25.

As surfactants one or more surfactants, especially anionic surfactants and non-ionic surfactants and their mixtures can be used but also zwitter-ionic and amphoteric surfactants.

To be considered are alkylether carboxylates R—(OCH₂CH₂)ₓOCH₂COOM, with R being an alk(en)yl group of 12 to 18 carbon atoms, x stands for a number from 2 to 5 and M for an alkali, earth alkali or ammonium ion.

The anionic surfactants can be used in the form or their sodium, potassium or ammonium salts, as well as soluble salts of organic bases, such as mono-, di- and triethanolamine.

Anionic surfactants are preferably contained in the washing and cleaning agents of the invention in quantities of up to 10% by weight, and in particular in quantities of 0.5 to 5% by weight.

As non-ionic surfactants alkoxylated, preferably ethoxylated and/or propoxylated, preferably primary alcohols with preferably 8 to 18 C-atoms and on average 1 to 12 moles ethylene oxide (EO) and 2 to 17 moles ethylene oxide (EO)/propylene oxide (PO) per mol alcohol are used, in which the alcohol group can be linear or preferably in 2-position methyl-branched or can contain a mixture of linear and methyl-branched groups, as they usually are present in oxoalcohol groups. Preferably used are alcohol ethoxylates with linear groups from alcohols of native origin with 12 to 18 C-atoms, e.g. from coconut oil, palm oil, tallow fat or oleyl alcohol, and an average 2 to 8 EO per mol alcohol, especially preferred C₁₂-C₁₄-alcohols with 3 EO or 4 EO, C₉-C₁₁-alcohols with 7 EO, C₁₃-C₁₅-alcohols with 3 EO, 5 EO, 7 EO or 8 EO, C₁₂-C₁₅-alcohols with 3 EO, 5 EO or 7 EO and mixtures from these, such as mixtures of C₁₂-C₁₄-alcohols with 3 EO and C₁₂-C₁₅-alcohols with 7 EO, laurylalcohol with 7 EO and 10 PO, laurylalcohol with 2 EO and 4 PO, laurylalcohol with 4 EO and 5 PO, laurylalcohol with 5 EO and 4 PO, laurylalcohol with 6 EO and 4 PO, laurylalcohol with 8 EO and 4 PO, C₁₀-C₁₂-alcohol with 4 EO and 4 PO, isodecylalcohol with 2 PO and 12 EO, isodecylalcohol with 2 PO and 4 EO, undecylalcohol with 8 EO and 2PO, C₁₂-C₁₅-oxoalcohol with 2 EO and 5 PO, C₁₂-C₁₅-oxoalcohol with 4EO and 4 PO, C₁₂-C₁₅-oxoalcohol with 5 PO and 2 EO, C₁₂-C₁₅-oxoalcohol with 6 EO and 4 PO, C₁₂-C₁₅-oxoalcohol with 8 EO and 4 PO, C₆-C₁₂-alcohol with 6 EO and 8 PO.

The above specified degrees of ethoxylation and degrees of propoxylation represent statistical averages, which can be a whole or a fractional number for a specific product.

The weight ratio of one or more bleaching catalysts to one or more surfactants is typically from 1 to 10000 to 1 to 1000, preferably from 1 to 5000 to 1 to 3000.

Enzymes to be considered are those enzymes commonly used in washing and cleaning agents, such as proteases, amylases, mannasesn, lipases, endolases, pectinases, cellulases, pullinases, cutinases or peroxidases, phospholipases, cellobiohydrolases, esterases, keratinases, reductases, oxidases, ligninases, arabinosidases, glucosinases and/or perhydrolases.

Available proteases, for example, are Liquanase<®> Ultra 2,0 XL, BLAP<®>, Opticlean<C>, Maxacal<®>, Maxapem<®>, Esperase<®>, Savinase<®>, Purafect<®>, OxP and/or Duraxym<®>,

available amylases, for example, are Steinzyme<®> Plus 12L, Termamyl<®>, Amylase<®> LT, Maxamyl<®>, Duramyl<®> and/or Pruafect<®> Ox, available mannases, for example, are Mannaway 4,0 L,
available lipases, for example, are Lipex<®>100 L, Lipolase<®>, Lipomax<®>, Lumafast<®> and/or Lipozym<®>,
available endolases, for example, are Endolase<®>5000L,
available pectinases, for example, are Pectinex 3X L and/or Pectinex Ultra SPL and
available cellulases, for example, are Carezyme 1000 L and/or Celluclast 1.5 L.

The weight proportion of one or more bleaching catalysts to one or more enzymes is typically from 1 to 100 to 100 to 1, preferred from 1 to 10 to 10 to 1, particularly preferred from 1 to 5 to 5 to 1 and most preferred from 1 to 3 to 3 to 1. The weights of enzymes refer to 100% of enzyme protein.

Suitable binders are homo- or copolymeric polycarboxylates, in particular polymers or copolymers of acrylic acid and/or of methacrylic acid (hereinafter also called “poly-(meth)acrylic acid”), preferably in the form of their salts or in partially neutralized form. These can preferably be used 1% dissolved in water and have a pH-value of 3 to 9, but in particular between 3.5 and 8.5. Preferably used are polyacrylic acid or polymethacrylic acid, particularly those with an average molar mass of 500 to 70,000 g/mol.

Poly(meth)acrylates, preferably those having a molar mass of 2,000 to 20,000 g/mol are preferred. Due to their superior solubility from this group in particular short-chain poly(meth)acrylates are preferred, which have molar masses of 2,000 to 10,000 g/mol, and very preferred of 3,000 to 5,000 g/mol.

Additional anionic polymers preferably used as binders are sulfone-group containing polymers, in particular copolymers of unsaturated carboxylic acids with sulfone-group containing monomers and optionally with other ionic or non-ionic monomers.

As builders to be considered are water-soluble organic builder compounds, preferably polycarboxylic acids or their salts, particularly citric acid and sugar acids, aminopoly-carboxylic acids, in particular N-methylglycine diacetic acid or its salt (MGDA), glutamine diacetic acid or its salt (GLDA) and ethylene diamine disuccininc acid or its salt (EDDS), nitrilo triacetic acid and ethylene diamine tetraacetic acid, or polyaspartic acid. Polyphosphonic acids, especially aminotris(methylenephosphonic acid), ethylenediamine tetrakis(methylene-phosphonic acid) and 1-hydroxyethane-1, 1-diphosphonic acid can also be used.

Further preferred builders or co-builders are also polycarboxylic acids, in particular the polycarboxylates which are accessible by oxidation of polysaccharides and of dextrins, respectively, as described in WO 93/16110 A1, WO 92/18542 A1 or EP 0 232 202 A2, as well as polymer acrylic acids, methacrylic acids, maleic acids and mixed polymers from these which can contain incorparated by polymerization small amounts of polymerizable substances without carboxylic acid functionality.

In addition to polyphosphonates and phosphonate alkyl carboxylates further possible water-soluble builder components are for example organic polymers of native or synthetic origin of the above type of polycarboxylates that act particularly in hard water areas as co-builders, and of course naturally occurring hydroxycarboxylic acids, such as mono-, dihydroxy succininc acid, alpha-hydroxypropionic acid and gluconic acid. Equally the salts of citric acid, particularly sodium citrate, as well as anhydrous trisodium citrate or trisodium citrate dihydrate, can be employed.

As inert substances SiO₂ or TiO₂ come into consideration, for example.

As further additives, for example, oxalic acid, ascorbic acid and glyoxalic acid esters and their acetals or hemiacetals, which increase the effectiveness of the bleaching catalysts, come into consideration.

The mixtures containing bleach catalyst powders of the invention and additional agents can be mixed and granulated according to conventional methods.

According to a preferred manufacturing method the bleach catalyst powders of the invention are mixed with a bleach activator and with a polycarboxylic acid and are processed to co-granulates as described in WO 2014/198369 A1.

Preferred bleach catalyst co granulates have an average particle size between 0.1 and 1, 6 mm, preferably between 0.2 and 1.2 mm and particularly preferred between 0.3 and 1, 0 is mm, each measured by sieve analysis.

Preferred washing and cleaning agents of the invention, in particular the agents for the machine cleaning of dishes, contain the bleach catalyst powders of the invention typically in amounts with a manganese content of 0.0005% by weight to 0.3% by weight, referring to the finished agents for the machine cleaning of dishes that can be available as granulates, as powdery solids or in tablet form but also in form of a liquid or paste.

The dishwashing agents of the invention may contain in particular builders, per-oxygen compounds, enzymes, alkaline media, surface active tensides, pH regulators, organic solvents and additional auxiliary materials, such as glass corrosion inhibitors, silver corrosion inhibitors and foam regulators. The bleach catalyst powders of the invention are both suitable for the use in phosphate-containing and in phosphate-free formulations.

Especially preferred washing and cleaning agents, preferably agents for the machine cleaning of dishes, contain

15 to 65% by weight, preferably 20 to 60% by weight, of a water-soluble builder,
5 to 20% by weight, preferably up to 8% by weight, of a per-oxygen compound,
0.0005% by weight to 0.3% by weight Mn-content of a bleach catalyst of the invention, and
0 to 50% by weight of other additives, such as enzymes, alkaline media, surface active tensides, pH regulators, organic solvents or additional auxiliary materials, such as glass corrosion inhibitors, silver corrosion inhibitors and foam regulators, each based on the total weight of the dish washing agent.

Such an agent is particularly low alkaline, i.e. its 1-% by weight solution has a pH-value in the range of 8 to 11.5, and preferably of 9 to 11.

The following examples are supposed to illustrate the invention without restricting it. All percentages are understood as weight percent (% by weight), unless explicitly otherwise stated otherwise.

Example: Process according to the invention for milling of bis (N,N′,N″-trimethyl-1,4,7-triazacyclononane)-trioxo-dimanganese (IV) di(hexafluorophosphate) monohydrate, prepared according to EP 0 458 397 A2

### Example 1 (According to Invention)

50 kg of commercial Peractive MnTACN from WeylChem Wiesbaden were milled under nitrogen at a throughput of 8 kg/h in a commercial spiral jet mill from Alpine 100 AFG. The product temperature was measured in the mill stream using PT100 and was maximum 45° C. Connected to the mill was a separation device for separation of coarse material which was immediately re-introduced into the milling process. The parameters of the separation device had been adjusted so that an upper grain size limit D₉₇<30 μm is met.

The chemical analysis of the milled material showed that there was no measurable degradation of the original activity of the MnTACN. By means of laser diffraction using the standard ISO13320 (2009) in the milled material a D₉₉<50 μm and a D₁₀<1 μm was determined.

### Example 2 (Comparison Example)

Commercial Peractive MnTACN from WeylChem Wiesbaden GmbH was added in doses to a continuous cross hammer mill of IKA (type MFC KB15) using a perforated inset of 0.6 mm and a speed of up tp 5000 rpm. The product thus obtained was investigated by light microscope type SZH-ILLP from Olympos and still contained clearly needle-shaped structures, with high percentages of coarse particles having a particle diameter above 50 μm being present in addition to very fine particles. The coarse, needle- or rod-shaped particles having a particle diameter of more than 50 μm could not be comminuted with the cross hammer mill or only on a very small scale.

Also using even finer perforated insets of 0.2 mm and repeated addition into the mill when using this milling technique the proper particle size distribution of the invention could not be adjusted.

### Example 3 (Comparison Example)

500 kg commercial Peractive MnTACN from WeylChem Wiesbaden with a D₉₇ of 120 μm were milled within 24 hours through a screen of 150 μm in a commercial sieve mill from Alexanderwerk (type RFG150) at a rotational speed of 1 m/s. The product temperature measured in the mill stream using PT100 was maximum 45° C. The obtained product had a D₉₇ of 83 μm. Under the microscope (light microscope from Olympus) both very small particles having a particle diameter of <10 μm but also a very large proportion of rod-shaped material with a length of clearly above 100 μm could be detected. All in all, it was not possible with this milling technique to make the particle size distributions of the invention even when using the finest screen and multiple passages.

### Example 4 (Comparison Example)

In an Alpine pin mill UPZ315 of Alpine with smooth pin disc 500 kg commercial Peractive® MnTACN from WeylChem Wiesbaden were milled in continuous milling process at a rotor rotational velocity of 9000 rpm with a throughput of about 240 kg/h. The maximum product temperature here obtained was maximum 44° C. after the milling step (measured at the outlet by means of PT100).

The product showed a very significant lump formation (up to 2 cm) with black coloring of the interior of the lumps. Size and hardness of these clumps make a further processing of the milled material impossible.

In addition to the physical disadvantages, a significant loss of activity of the initial product by up to 50% was detected. This is probably caused by a too high heat load during the milling process. Black coverings on the pins indicate such a decomposition mechanism.

### Machine Dishwashing Agent

| composition | % by weight (tel quel) |
|---|---|
| Peractive ® MnTACN milled | 0.015 |
| according to example 1 | |
| MGDA | 20 |
| sodium citrate | 13 |
| sodium carbonate | 25.5 |
| Sokalan ® PA3OCL | 6 |
| sodium percarbonate | 15 |
| Genapol EP 2544 | 1.5 |
| Blaze evity ® 100 T | 0.7 |
| Stainzyme ® 12T | 0.6 |
| sodium sulfate | 17.685 |

### Commercial Products Used

MGDA (alanine, N,N-bis(carboxymethyl)-, trisodium salt), manufacturer BASF AG
Peractive® MnTACN, Mn-bleaching catalyst, manufacturer Weylchem Wiesebaden
Sokalan® PA3OCL, polycarboxylate, manufacturer BASF AG
Genapol® EP 2544, C₁₂/C₁₅-oxoalcohol EO-PO adduct, manufacturer Clariant
Blaze evity® 100 T, enzyme mixture, manufacturer Novozymes
Stainzyme® 12T, enzyme, manufacturer Novozymes

Manufacturing method: The components sodium carbonate, sodium citrate and sodium sulfate were provided, homogenously mixed in a Lödige mixer at room temperature during a period of 15 minutes and transferred into a Turbula mixer. Genapol® EP2544 was added slowly into the Turbula mixer and mixed homogeneously during a period of 10 minutes. All other components were added one at a time and were homogeneously mixed for a period of 10 minutes.

This dishwashing agent showed a very good cleaning effect, notably vis-à-vis tea stains.

1. Fine-particulate powder containing particles with at least 80% by weight of a manganese complex with nitrogen-containing ligands, wherein one or more of the ligands are macrocyclic ligands, wherein at least 70% by weight of the particles have particle sizes in the range from 1 μm to 50 μm, at most 15% by weight of the particles have particle sizes >50 μm and at most 15% by weight of the particles have particle sizes <1 μm, wherein the percentages refer to the total amount of the particles.

2. The fine-particulate according to claim 1, wherein the manganese complex is a complex of manganese in the oxidation state II, III or IV, which contains one or more macrocyclic ligand(s) with the donor functions N and/or NR, in which R stands for a hydrocarbon residue with up to 20 C-atoms.

3. The fine-particulate powder according to claim 1, wherein the manganese complex has the following formula (1) or (2) 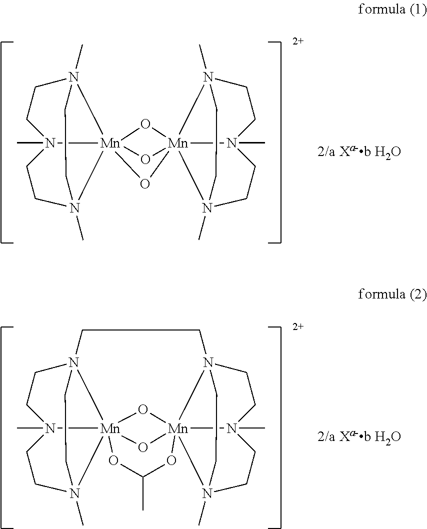
wherein a is 1 or 2, b is a number from 0 to 4, and X stands for any monovalent or bivalent anion.

4. The fine-particulate powder according to claim 3, wherein X stands for PF₆⁻, CH₃COO⁻, Cl⁻, or SO₄²⁻.

5. The fine-particulate powder according to claim 3, wherein the manganese-complex is bis (N,N′,N″-trimethyl-1,4,7-triazacyclononane)-trioxo-dimanganese (IV) di(hexafluorophosphate) monohydrate.

6. The fine-particulate powder according to claim 1, wherein the powder does not contain particles with particle sizes of above 100 μm and/or does not contain particles with particle sizes of below 100 nm.

7. The fine-particulate powder according to claim 1, wherein at least 90% by weight of the particles have particle sizes in the range from 2 μm to 50 μm, at most 5% by weight of the particles have particle sizes >50 μm and at most 5% by weight of the particles have particle sizes <2 μm, wherein the percentages refer to the total amount of particles.

8. The fine-particulate powder according to claim 1, wherein the powder has volume-average particle sizes D₅₀ in the range from 2 to 25 μm.

9. The fine-particulate powder according to claim 1, wherein the powder has volume-average particle sizes D₉₇ in the range from 8 to 35 μm.

10. The fine-particulate powder according to claim 9, wherein the powder has volume-average particle sizes D₉₇ in the range from 10 to 30 μm.

11. The fine-particulate powder according to claim 10, wherein the powder has volume-average particle sizes D₉₇ in the range from 11 to 25 μm.

12. The fine-particulate powder according to claim 11, wherein the powder has volume-average particle sizes D₉₇ in the range from 12 to 20 μm.

13. A process for preparing a fine-particulate powder containing particles with at least 80% by weight of a manganese complex with nitrogen-containing ligands, wherein one or more of the ligands are macrocyclic ligands comprising:
i) introducing a milling stock of particulate material comprising at least 80% by weight of manganese complexes with nitrogen-containing ligands, wherein of the ligands one or more are macrocyclic ligands, into a milling device selected from the group consisting of a jet mill or a pen mill equipped with a cooling device, wherein the milling device is equipped with a separator device,
ii) milling of the particulate material to a fine-particulate powder, with the proviso that
iii) the temperature of the milling stock during the milling process does not exceed 95° C.

14. The process according to claim 13, wherein the milling in step ii) takes place under such conditions, that at least 70% by weight of the total amount of the particles of the obtained fine-particulate powder possess particle sizes in the range of 1 μm to 50 μm, at most 15% by weight of the particles possess particle sizes of >50 μm and at most 15% by weight of the particles possess particle sizes of <1 μm.

15. The process according to claim 13, wherein the temperatures of the milling stock during the milling process are from −15° C. to 95° C.

16. The process according to claim 13, wherein the temperature of the milling stock during the milling process is controlled by supply of cooling gas or by supply of liquefied gases.

17. The process according to claim 13, wherein the coarse particles separated in the separator device are reintroduced into the jet mill or into the cooled pen mill.

18. The process according to claim 13, wherein manganese complexes containing particulate material is milled in a dry state.

19. The process according to claim 13, wherein particles with a very broad particle size distribution of 2 μm to 0.1 mm containing 80 to 100% by weight of a manganese complex with nitrogen containing ligands, wherein of the ligands one or more are macrocyclic ligands, are milled in a dry process using an air-powered jet mill containing downstream a separator device.

20. A method of formulating washing and cleaning agents comprising incorporating the fine-particulate powder according to claim 1 into the washing and cleaning agents as a bleaching catalyst for per-compounds in the washing and cleaning agents.

21. The method according to claim 20, wherein the washing and cleaning agent is a dishwashing agent.

22. Washing and cleaning agent comprising the fine-particulate powder according to claim 1.

23. The washing and cleaning agent according to claim 22, wherein this contains a per-compound.

24. The washing and cleaning agent according to claim 22, wherein the fine-particulate powder is applied to a carrier material and/or is a compound with a bleach activator.
